(19) United States
(12) Patent Application Publication
(10) Pub. No.: US 2015/0224904 A1
(43) Pub. Date: Aug. 13, 2015

(54) EZ-Off Trailer Floors

(71) Applicant: Nicholas Taylor Kolster, San Angelo, TX (US)

(72) Inventor: Nicholas Taylor Kolster, San Angelo, TX (US)

(21) Appl. No.: 14/177,814

(22) Filed: Feb. 11, 2014

(51) Int. Cl. B60P 1/36; B62D 63/08

(52) U.S. Cl. CPC B60P 1/36; B62D 63/08

(57) ABSTRACT

E-Z Off Trailer Floors are designed to allow quicker and easier unloading of trash/debris in a trailer. Moving floors below the trash/debris are connected to a motor. Once the ‘On’ Switch is flipped, the floor rotates under the trailer and back up to the top of the floor allowing the trash/debris to fall out of the back of the trailer as the floor moves. The floor moves at a steady pace which allows the trash/debris to unload within a few minutes. This alleviates back-breaking work that would incur while manually unloading the trash/debris.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

EZ-Off Trailer Floors allows persons to easily unload trash/debris with the ‘flip of a switch’ which saves back-breaking work as well as time.

### BRIEF SUMMARY OF THE INVENTION

With the ‘flip of a switch’, back-breaking work becomes easy to do. Unloading trash in 2-3 minutes with EZ-Off Trailer Floors saves time and hassle when going to the county dump. The smell at the county dump is horrendous therefore this quick unload will help.

### BRIEF DESCRIPTION OF THE SEVERAL VIEWS OF THE DRAWING

FIG. 1 shows a side view of a trash trailer. This view also shows the back sprocket for the drag chain, listed in the claim.

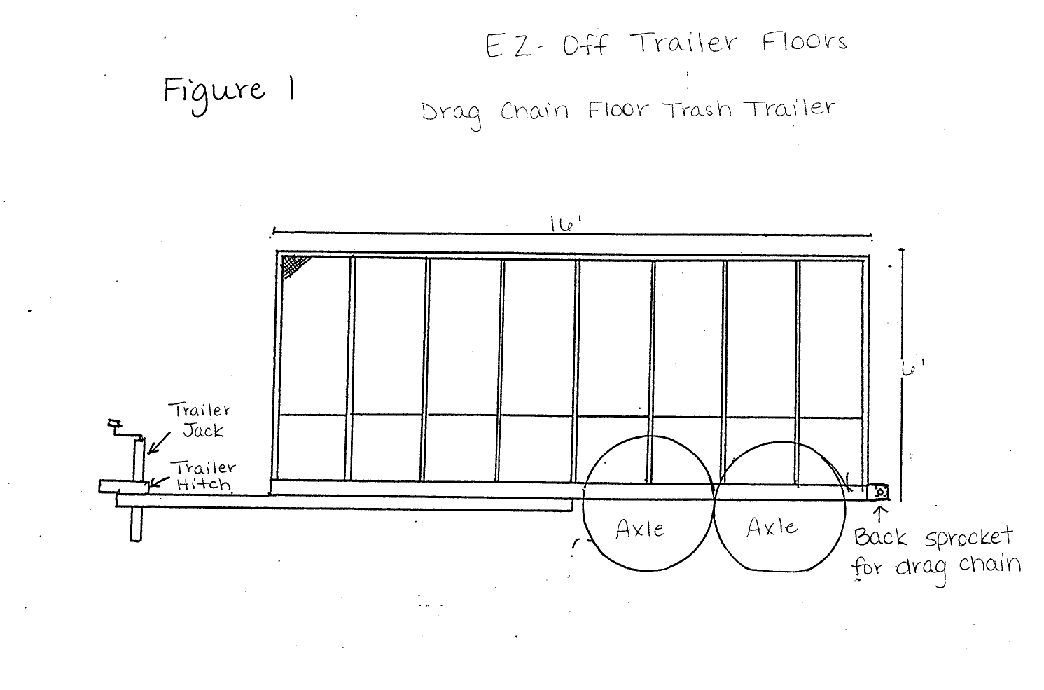

FIG. 2 shows also shows a side view while more specifically showing the 1″ HUBS, sprockets, chains, motor, and battery, listed in the claim.

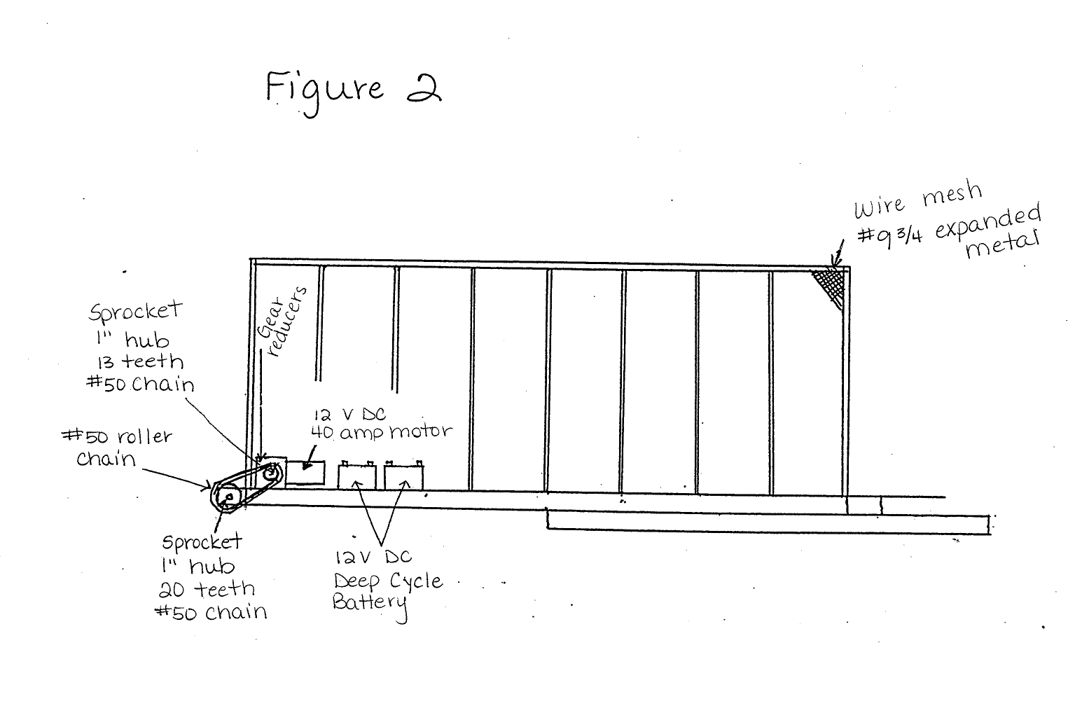

FIG. 3 shows the top view of the drag chain floor while more specifically showing the movement/rotation of the drag floor with all important parts, listed in the claim.

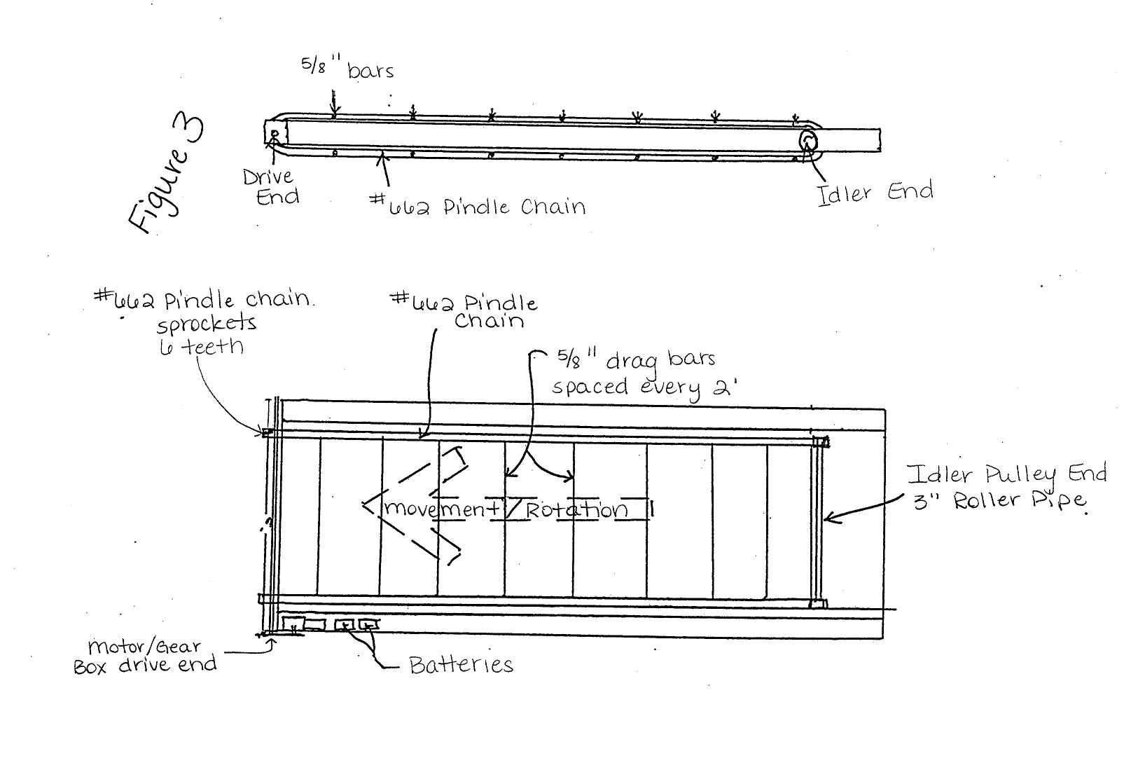

FIG. 4 shows the rear view of the trailer specifically pointing to the ⅝″ drag bars, motor gear box, and 4″ block bearing, etc, listed in the claim.

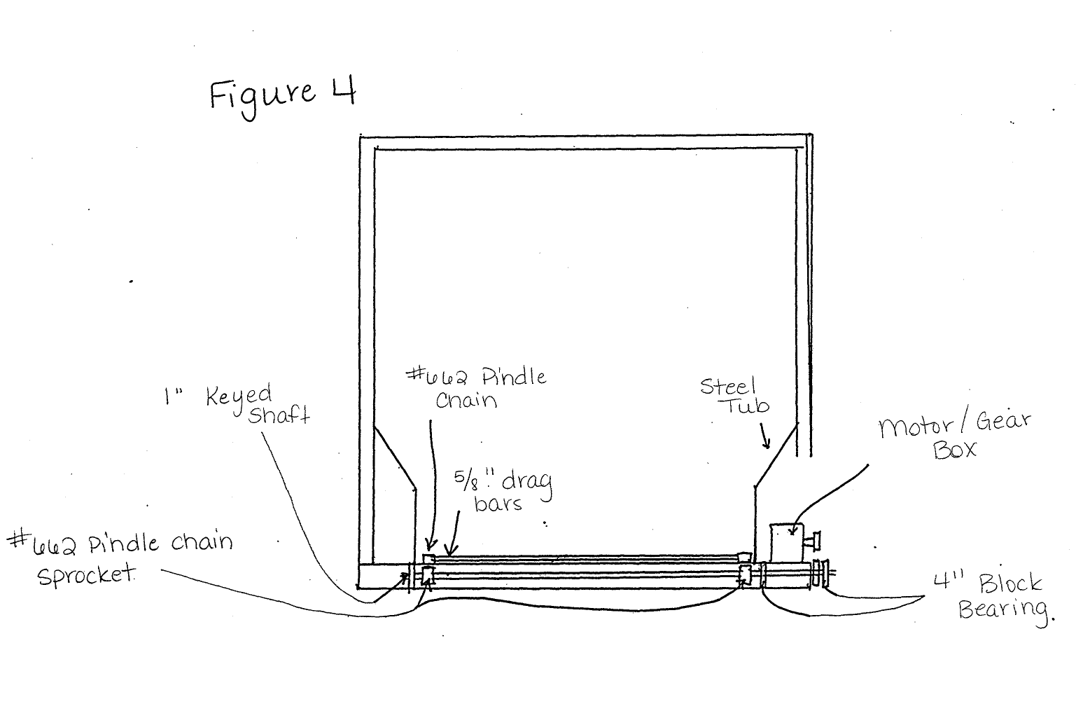

### DETAILED DESCRIPTION OF THE INVENTION

E-Z Off Trailer Floors were designed to allow quicker and easier unloading of trash/debris in a trailer. These moving floors below the trash/debris are connected to a motor. Once the ‘On’ Switch is flipped the floor rotates under the trailer and back up to the top of the floor allowing the trash/debris to fall out the back of the trailer as the floor moves. The floor moves at a steady pace which allows the trash/debris to unload within a few minutes. This alleviates back-breaking work that would incur while manually unloading the trash/debris.

1. An EZ-Off Trailer Floor comprising:
1. 3 Sprocket for drag chain
2. 1″ HUB, 20 teeth, #50 chain
3. 1″ HUB, 13 teeth, #50 chain
4. #50 chain
5. Gear Reducers
6. 12 VOC, 40 AMP Motor
7. 12 VOC Battery
8. Drive end
9. Idler end
10. #662 Pindle chain
11. #662 Pindle chain sprocket
12. Sprocket with 6 teeth
13. ⅝″ Drag bars
14. Motor/Gear Box drive end
15. Idler Pulley end, 3″ roller pipe
16. 1″ keyed shaft
17. 4″ block bearing
18. Motor gear box
